(19) United States
(12) Patent Application Publication
(10) Pub. No.: US 2007/0184161 A1
(43) Pub. Date: Aug. 9, 2007

(54) Square dough products and method of making the same

(76) Inventors: John Edward McDonnell, Ramsey, NJ (US); Narciso Vallestero, Chestnut Ridge, NY (US); Barry Slobodow, Warren, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/349,204

(22) Filed: Feb. 8, 2006

(51) Int. Cl. A21D 6/00

(52) U.S. Cl. 426/502

(57) ABSTRACT

A dough sheeting system for sheeting highly viscous bagel dough is presented. A continuous sheet of bagel dough is sheeted on a sheeting table including a satellite roller device, a cross roller device, and a gauging roller device arranged in series. The sheeting table reduces the dough sheet to a final thickness and width before a slitting device incorporating a plurality of rotary disc cutters, cuts the dough sheet into a plurality of dough sheets. Then a docker device cuts and virtually simultaneously presses the plurality of dough sheets to create a depressed center portion. A second cycle of the docker device cuts and presses again the depressed center portions of each newly created bagel dough piece. A spreading belt conveyor, a reciprocating conveyor, and a board indexing conveyor transport the bagel dough pieces to a proofing board for proofing and processing.

### FIELD OF THE INVENTION

This invention relates to a traditional bagel food product made and shaped in a non-traditional way. In particular, this invention relates to a hole-less bagel shaped like a rectangle or square and mass produced with proprietary equipment radically different from the typical bagel making equipment. Modification of the bagel dough ingredients and bagel dough preparation and handling contributes to the successful production of the new food product.

### BACKGROUND OF THE INVENTION

Traditionally, bagels are boiled in water before they're baked, which reduces the starch content and creates a chewy crust. The traditional water bagel is made without eggs and, because it doesn't contain fat, is chewier than an egg bagel. Bagels come in dozens of varieties, from sweet to savory, and may contain dried fruit, nuts, seeds (usually poppy or sesame), herbs, spices, or sweeteners. They're available in whole-wheat, white, and multi-grain varieties.

In the typical bagel dividing procedure, the dough is cut to the desired weight. Each piece is formed into a bagel by rolling the dough piece ends until they form a circular piece. Previous methods used to gather the dough at a desired weight have included hand forming methods as well as machine methods. This is done by using vertical or horizontal forming machines. See FIG. 2 of the specification. This method is slow, labor intensive, and unsuitable to producing the large quantities of bagels that a large scale manufacturer may require. Additionally, the bagels will not necessarily be of uniform size and weight.

Machines are generally used to divide the dough into uniform lumps which are then used to form an uncooked bagel. These machines are equipped with a dividing apparatus such as pistons, blades, or extruders. The dividing apparatus may be fed manually or by a dough hopper. These machines may be designed either for manual removal of the dough pieces or direct feeding into the next process of an automated, or semi automated, production line. The use of machines allows bakers, and larger bagel manufacturers, to produce a greater number of bagels of uniform weight than using traditional hand-forming methods.

Each divided dough piece is formed into a bagel by joining the end pieces of a string of dough and rolling the dough piece ends until they form a circular piece. It is generally preferred to rely on automation, as a machine will shape the divided dough into an uncooked bagel of consistent shape and size more quickly and with greater efficiency. Bagel shaping machines may be vertical or horizontal forming machines. Examples of some of these machines may be found in detail in U.S. Pat. Nos. 4,336,010; 4,478,565; 4,799,875; 5,664,486; 5,770,242; and 6,165,527, the disclosures of which are incorporated herein by reference thereto. A drawback of the previous bagel dough shaping machines, and production lines that use these machines, is that different shapes cannot be made. Each bagel is formed in the traditional shape, with little tolerance in shape permitted by design.

The traditional toriodal bagel shape presents problems for consumers who want to prepare and eat a sandwich using the bagel as bread. Said bagels have a hole, between about ⅜ths inch and 1 inch in diameter, that extends through the center of the bagel. Square bagels are known, said bagels also having a hole therethrough. Generally, bagels used to form sandwiches are cut to form two pieces, an upper half and a lower half. Consumers demand a bagel-like appearance, that is, having an apparent hole in the center. The bagel hole has another important function. Bagels are typically boiled or steamed, and the hole allows better drainage of water from the bagel. The traditional bagel with its hole is not desirable as a sandwich because it fails to keep in sandwich ingredients and condiments, exposes sandwich ingredients to the outside of the sandwich, and does not provide a delicious taste of bagel in every bite. The hole in the bottom half of the bagel is particularly problematical, as when a bagel sandwich is being consumed some of the sandwich internal contents—condiments, meats, vegetables, and the like—can be extruded out the large hole in a manner that the consumer can not see, typically resulting in a mess. Also, once a bagel is bitten through at one point, the toroidal shape loses much of its strength, again leading to the sandwich falling apart as it is being consumed.

What is needed is a bagel product useful for sandwiches that does not have the disadvantages of the traditional bagel. What is also needed is a method of manufacturing the aforesaid bagel product in a cost effective, fast, automated process that has minimal dough waste or recycle, and also the machinery and apparatuses necessary for carrying out the manufacturing process.

### SUMMARY OF THE INVENTION

The present invention includes a device, a method, and compositions for rapidly making shaped bagel products. The invention also includes novel bagel products made by the process.

An aspect of the present invention is to provide a non-traditional hole-less bagel product for use as sandwich bread. Another aspect of the present invention is to provide a non-traditional hole-less bagel product that keeps sandwich ingredients inside the sandwich and does not expose them to the outside.

Another aspect of the present invention is to provide a non-traditional bagel product with a central depression reminiscent of the traditional bagel shape. In a preferred embodiment, a bagel product of the present invention, if cut substantially in two even pieces along a horizontal plane, will provide two halves, the top half having a hole-like indentation therein, though neither half having a hole piercing through the center thereof. In another embodiment, a bagel product of the present invention, if cut substantially in two even pieces along a horizontal plane, will provide two halves, the top half having a traditionally sized hole piercing through the center thereof, the bottom half optionally comprising a hole-like indentation therein, though the bottom half does not have a hole piercing through the center thereof. Another aspect of the present invention is to provide a non-traditional bagel product that has the appearance of a hole, or in other embodiments actually has a hole, extending through the top half of a bagel product, and has no hole, or a small hole having a diameter less than 0.25 inches, for example less than 0.2 inches, but large enough for water to drain from the hole, for example greater than 0.01 inches, typically greater than 0.03 inches.

The bagel product can be round, but preferably another aspect of the present invention is to provide a non-traditional bagel product shaped like a polygon e.g., preferably a rectangle and square.

Another aspect of the present invention is to provide a non-traditional bagel product that is produced by non-conventional bagel making equipment.

Another aspect of the present invention is to provide proprietary equipment and methods for sheeting, cutting, forming, and cooking highly viscous dough used in making bagels to form the a non-traditional bagel product Another aspect of the present invention is to provide a docker device for impressing a central depression in highly viscous bagel dough, said impression being sufficient to provide the appearance of a bagel hole in. the top of the dough after subsequent proofing and cooking processes. As used herein, the “docker” is defined as the protruding element that is impressed into the dough, and which forms the desired depression. Some embodiments further include a “dowel”, pin, or pusher, which is much smaller in diameter than the docker, and which is extendible from the protruding face of the docker.

Another aspect of the invention is to provide a manufacturing method to form the non-traditional bagel products such as those listed above wherein a plurality of bagel products are formed simultaneously from a sheet of dough, and wherein waste is minimized. This method for producing shaped bagels includes sheeting bagel dough, shaping the bagel dough into one,or more predetermined shapes using cutters and a docker device or devices to shape the bagel dough, and proofing and processing the shaped bagel dough to produce a non-traditional shaped bagel product that reaches the desired shape after proofing and processing. This method and result is somewhat surprising because bagel dough is very dense and visco-elastic, and the dough has a tendency to want to conform back to its original shape (or more frequently to other undesirable shapes) when distorted. The combination of rolling, pressing, and cutting, as well as having the dough portions disposed against one another, each contribute to overcome this tendency. The proprietary ingredients, including defined quantities of enzyme modified gluten, potassium sorbate, calcium propionate, vital wheat gluten, ascorbic acid, salt, sugar, yeast, flour, water and enzymes, are also critical for allowing the viscous dough to be managed on the sheeting table.

Another aspect of the present invention is to provide a bagel product with a shelf-life of about two weeks.

Briefly, a dough sheeting system for sheeting highly viscous bagel dough is presented. A continuous sheet of bagel dough is prepared in a hopper and undergoes a plurality of rolling processes including a satellite roller device, a cross roller device, and a gauging roller device arranged in series. The plurality of rollers allows the dough to be repeatedly formed into a sheet of the desired thickness. The dough is disposed on a sheeting table. The gauging roller disposed above the sheeting table reduces the dough sheet to a final thickness, typically between ⅜ inch and ¾ inch, more typically between ½ inch and ⅝ inch, and final width, typically a multiple between 2 and 24 times, more typically a multiple between 4 and 12 times the width of the resultant dough product before proofing, which is typically 3.5 plus or minus 0.5 inches, before a slitting device incorporating a plurality of rotary disc cutters cuts the dough sheet into a plurality of dough sheets. Preferably the dough is moving in a first direction across the sheeting table, and the cutters cut the sheet into a number of ribbons having approximately the same width as the resultant dough product before proofing, which again is typically 3.5 plus or minus 0.5 inches.

Then a cutter/docker device cuts portions of the dough sheets into bagel-sized portions and virtually simultaneously presses the plurality of dough sheets to create a depressed center portion for each newly created bagel dough piece. The cutting of the dough is in a direction at least partially perpendicular to the cuts made by the slitting device described above. It can be appreciated that the dough in a preferred embodiment is advantageously continuously moving across the face of the sheeting table, driven for example by rollers, conveyer belts, gravity, or the like. Cutting bagel squares necessarily takes time, and it is advantageous that the cutter assembly move (translate) with the dough while making the cut. Even more critical, use of a docker to form a hole or indentation into such viscous dough requires at least about a half second for dough to be translated out from the area where the depression is being formed, and it is advantageous that the docker assembly move (translate) with the dough while making the impression. Generally, steel, for example stainless steel, is advantageously used as the docker material as the force exerted on the dough must be high to form such a depression in the dough in for example a time between 0.3 second and 3 seconds. Steel, however, has poor releasing properties. At least for the first docker to be impressed into a piece of dough, in some embodiments there is a movable pin or extension device which extends outward from the end of the docker toward the dough as the docker is being withdrawn from the dough, wherein said pin promotes the separation of dough from the docker and optionally can be designed to form a very small hole through the bottom of the pressed area, that is, can optionally be used to form a small (typically less than ¼ inch in diameter, for example between about 1/64th and ⅛th inch in diameter) hole extending completely through the bagel product, wherein said hole will not readily allow condiments and other sandwich filling to be extruded out the bottom during consumption of a sandwich but wherein said hole can facilitate draining of boiling water or condensed steam encountered during the cooking process from the hole-like indentation in the bagel product. Use of high quality strong food grade plastic material such as Delrin® for the first docker is also useful, alone or as a coating over steel, provided the time to form a hole is such that the force can be moderated such that the plastic is not irreversibly deformed by the dockering system. In one preferred embodiment, a first docker formed of food grade steel is pressed into the dough and substantially formed the hole-like depression in the dough, and subsequent dockers are smaller (at least in diameter) than the first docker and can be made of a less resilient food grade plastic material, such as Teflon™ or Delrin®. We have surprisingly found that when a hole of very small diameter is made completely through the bagel product by for example extension of a pin from the front face of a steel docker into the dough where said docker has a small protrusion at the end to form a hole completely through the dough, that a second pressing of a second docker into the hole is highly beneficial. The second pressing does not move much dough material, but rather simply refines the bottom face of the pressed area to re-press the area where the hole was completely punched through the dough to prevent undesirable flowback of the dough during proofing and processing, and therefore the second docker need not be as resilient as the first docker and can be made of for example a food grade plastic. The second docker may be more rounded, and may have a partially hollowed out face. A plurality of sequential pressings may be useful, for example two or three pressings, using different dockers, where advantageously the final pressing is made by a docker of diameter less than at least one docker previously impressed into the dough, or by a docker formed of high release food grade plastic such as a fluoropolymer or fluoroplastic, or both.

The docker device may include a device body, one or a plurality of motors, one or a plurality of docker plates, one or a plurality of guillotine style cutting blade, one or a plurality of cylindrical dockers located in rows above the dough sheets, and a means for cutting and virtually simultaneously pressing the plurality of dough sheets. By pressing we mean a docker is pressed into the dough to form an indentation or depression. Advantageously in some embodiments the dowels if present that are extendible from the face of the docker make a small hole completely through the bagel-sized dough portions. In all embodiments, the depressed portion extends nearly completely through the thickness of the sheeted dough. As both the docker(s) and the cutters are both pressed into the dough, and as a result must if the dough is to move continuously move with the dough, in a preferred embodiment, the row of docker or rows of dockers and the cutter (or cutters) are single units or are a plurality of docker(s)/cutter combinations, one combination for each ribbon of dough moving along the sheeting table. Beneficially at least the first docker which is pressed into unproofed bagel dough product is disposed in front of the cutter (from the perspective of a moving sheet or ribbon of dough). Second and or subsequent dockers can be disposed before the cutter, after the cutter, or some combination thereof.

An alternate docker assembly may comprise a docker assembly movably located on or through a pressing face, where the pressing face is disposed against the top of the dough sheet during or after the period when the docker is impressed into the dough. When the docker is impressed into the dough, the dough that previously existed in the volume where the docker is impressed must ultimately be forced sideways, as the dough prior to proofing is not very compressible. In some instances, a ring or ridge might be formed by displaced dough which substantially alters the appearance of the flat sheet of dough. A pressing face which presses on the top of the dough can force such a ridge back down and at least partially move dough further away from the docker. If the pressing face is pressed against the surface of the dough as the docker is being removed, then the pressing face can facilitate separation of the docker from the dough. A pressing face, if present, can be formed of steel or beneficially formed of a high-release food grade plastic. In a preferred commercial embodiment no pressing face is used in conjunction with a docker.

The unproofed dough products having the hole or depression impressed therein can be subjected to an additional rolling step, which can substantially re-smooth the surface of the product. Such a rolling process can have the effect of elongating the dough product in one direction, and the unproofed dough product can be cut such that a subsequent rolling of product after forming the depression and making the cut at least partially perpendicular to the direction the dough is moving forms a resultant product that is either a square or a rectangle, as predetermined by the manufacturer. In a preferred commercial embodiment no rolling is performed after forming the depression in the dough and after cutting the dough into individual product-sized pieces.

In one embodiment the dough is pressed to form a depressed area while it is part of the dough sheet, and the dough with the depressed portion is to become the next portion in the process to be cut into a bagel-sized portion and pressed a second time to again flatten the depressed area. A spreading belt conveyor, a reciprocating conveyor, and a board indexing conveyor transport the bagel dough pieces comprising the depressed center portion to a proofing board or area for proofing and processing.

It is important to distinguish forming a depression by impressing a docker-type device into the dough sheet or ribbon, as opposed to forming a hole by using for example a cookie-cutter type device. The cookie-cutter type device forms a hole by removing dough. This creates a waste or recycle issue, forms a large hole extending through the bagel product which makes the resultant product not suitable for sandwiches, and it also creates issues with deformed shapes during subsequent proofing. If a depression is formed by impressing a docker into the dough, generally no dough is removed from the product, but dough is displaced from the depression to the product area (volume) adjacent to the depression. Such displacement has a significant effect during subsequent proofing. Bagel dough is visco-elastic and has a substantial memory. Bagel dough displaced by rolling and dockering has a strong tendency to recover its original shape during subsequent proofing. If a half inch thick dough sheet or ribbon is pressed with a docker to form a one inch in diameter depression into the dough product which extends between about 0.25 and 0.49 inches through the dough (leaving a layer having a thickness of 0.01 inches to 0.25 inches), the resultant product after proofing will contain either a very small indentation in the top of the final cooked product (for the initial hole that was about 0.25 inches deep) to a product having an indentation that extends between about 30% to about 80% of the way through the thickness of the final cooked product. In preferred embodiments, more than half of the area disposed below the face of the docker will have a thin layer of unproofed dough, for example between 0.005 and 0.25 inches thick, preferably between 0.01 and 0.1 inches thick, say between 0.03 and 0.08 inches thick. After proofing, the thickness of this very thin area will increase much more than does the thickness of the bagel product. Without being bound by theory, we believe dough flows back into the depression during proofing. Such flowback is necessary—a dough thickness of 0.1 inches or less will become crisp and breakable, like a cracker or toast, on baking, or will become mushy on cooking in boiling water, in either case losing the desirable texture of a bagel.

One method for producing shaped bagels includes sheeting bagel dough having water with approximately 40-60% by weight of flour, shaping the bagel dough into one or more predetermined shapes using rolling means and a cutting means, proofing and processing the shaped bagel dough to produce a shaped bagel that retains substantially the same shape after processing as after cutting. Surprisingly, to attain a uniform product, different docker sizes, rolled thicknesses, and even distances between a docker and a cutter are needed with various compositions, most importantly when whole wheat flour is used to replace some or all of the traditional refined bagel flour.

### BRIEF DESCRIPTION OF THE DRAWINGS

The accompanying drawings, which are incorporated herein and constitute part of this specification, illustrate embodiments of the invention, and, together with the general description given above and the detailed description given below, serve to explain various features of the invention:

FIG. 1 is a top perspective view of an embodiment of a bagel production line assembly made in accordance with principles of the invention; and

FIG. 2 is a side and top view of a conventional bagel production line assembly.

FIG. 3 is a bottom view of a docker plate and cutter assembly.

FIG. 4 is a side view of a docker plate and cutter assembly.

The above have been offered for illustrative purposes only, and are not intended to limit the scope of the invention of this application, which is described more fully in the drawings and claims sections set forth below.

### DESCRIPTION OF THE INVENTION

The following embodiments and aspects thereof are described and illustrated in conjunction with assays, methods, tools, and systems included in the invention and are meant to be exemplary and illustrative, not limiting in scope. In various embodiments, one or more of the herein-described problems have been reduced or eliminated, while other embodiments are directed to improvements of the assays, methods, tools, and systems described herein.

The inventors have developed unique equipment and methods for sheeting and cutting highly viscous dough for making bagels which allows the cut and shaped dough to attain a desired shape on proofing and cooking. The equipment and methods are unique in the ability to sheet, cut, and docker on a sheeting table. Also, the method of manufacture and the combination of ingredients play a critical role in allowing for two weeks shelf life at ambient temperatures.

### DEFINITIONS

As is generally the case in biotechnology and chemistry, the description of the present methods has required the use of a number of terms of art. Although it is not practical to do so exhaustively, definitions for some of these terms are provided here for ease of reference. Unless defined otherwise, all technical and scientific terms used herein have the same meaning as commonly understood by one of ordinary skill in the art to which the methods described herein belong. Definitions for other terms also appear elsewhere herein. However, the definitions provided here and elsewhere herein should always be considered in determining the intended scope and meaning of the defined terms. Other than in the operating examples or where otherwise indicated, all numbers or expressions referring to quantities of ingredients, reaction conditions, etc., used in the specification and claims are to be understood as modified in all instances by the term “about.”

As used herein, the term “bagel dough,” refers to very turgid, high protein dough, such as known to make bagels using conventional bagel-making techniques. Such dough is firm to the touch and easily rolled upon a floured surface. The dough is comprised of a mixture of flour, water, yeast, salt, and additionally sugar and other additives. The flour should be high gluten flour, such as good clear spring wheat flour with protein content of typically 13.5-14% of flour weight. In one embodiment water should be added in a quantity of typically 50-53% of flour weight. Salt content should typically be 1.5-2.2% of flour weight. Yeast should be added in a quantity of typically 0.5-2% of flour weight. Sugar, which serves as a food for the yeast and not as a contributor to the final product, should be a dextrose, corn syrup, high fructose or other fermentable sugar, and can be added up to 4% of flour weight. Residual sugar contributes to the browning of the crust during baking. See, for example, U.S. Pat. No. 6,444,245, for traditional bagel dough compositions which are adaptable for use in the present invention.

As used herein, the term “bagel wheat flour” refers to a grain constituent that is frequently used in baked goods. Suitable flours include hard wheat winter and spring flours with protein ranges of from about 10 weight percent to about 16 weight percent protein, based on the weight of the flour. High protein flour (containing between about 12 and about 16 weight percent protein) is preferred, because proteins facilitate conditioning and strengthening of the sponge. Although less preferred, soft wheat flour or lower protein flours can also be used. See, for example, U.S. Pat. No. 6,884,443.

As used herein, the term “proofing” refers to the process of fermentation i.e., allowing the dough to rise a desired amount. The term processing includes cooking.

A. Dough

Although it is possible to obtain and mix all the separate individual ingredients necessary for making bagel dough, it has been found more convenient to form the bagel dough using a premixed powdered base. Said premixed powdered base generally comprises a number of the additives to be added to the dough, including for example sugars, salt, reducing agents, oxidizing agents, blowing agents, Vital Wheat Gluten, preservatives, softeners, vitamin and mineral fortifiers, and/or other additives such as yeast, flavorants, specialty flours, and the like, and may further comprise a small portion of the flour to be added to the dough. For example, 16 lbs. of base are mixed with 5 lbs. of water at 50-55° F. If the water is too hot, the yeast may subsequently be too active and overdevelop, thus the initial water temperature should not exceed 55° F. To this base and water are added 14 oz. of yeast then 100 lbs. of high gluten flour. The preferred flour is high in ash and protein and gives the bagel product a distinctive chewy texture. See, for example, U.S. Pat. No. 6,444,245.

The amount of water added can be enough to provide the final dough composition with an amount of water that is effective to provide a desirable bagel dough composition consistency. Water can act as a plasticizer, a leavening agent, or both. When water acts as a plasticizer, water provides the dough composition with extensibility. Desirable extensibility facilitates baking the dough composition into a product having a desirable baked specific volume. Moreover, water can facilitate the leavening of the dough composition by forming steam, which acts to expand the dough.

Vital wheat gluten is used as a strengthener, although other strengtheners, such as transglutaminase, can be used in addition to or as an alternative to vital wheat gluten in the practice of the invention. The strengthener is useful for increasing the strength and extensibility of a sponge (dough being proofed). The use of the strengthener can increase the gas-holding capacity of the sponge by allowing the sponge to expand instead of breaking upon evolution of carbon dioxide by the yeast; i.e., the strengthener can provide desirable viscoelastic properties. For example, a sponge may be used to used to make sour dough bagels.

Other Ingredients.

Dough compositions also typically include sugar and salt. Salt can enhance the flavor of a baked product prepared from a dough composition of the invention, impart toughness to the gluten, and provide strength to the crumb. Salt can be present in an amount effective to provide a desirable flavor. Salts are typically present in a range of between about 0.3 weight percent and about 3 weight percent but may be present in a range from 0-5%.

Sugar can also enhance the flavor of a baked product prepared from a dough composition of the invention. Sugar acts as a substrate for yeast and as a starting material for the Maillard reaction, which facilitates color formation of the crust. Sugar is typically present in a range of between about 1 weight percent and about 6 weight percent of the total dough composition but may be present in a range from 0-20%. Suitable sugars include granulated sugar, regular and high fructose corn syrup, sucrose (cane or beet sugar), dextrose, honey, etc.

The dough composition of the invention can also include other ingredients. Other agents which can affect the consistency and texture of the prepared product, including for example ascorbic acid, and aging agent/blowing agents such as azodicarbonamide, etc., can also be added to a dough composition of the invention to strengthen the dough. Additives such as emulsifiers, dough-developing agents, nutritional supplements, flavorings, shelf-life stabilizers, thickeners, organic acids, oxidizers, and the like can also be added to the dough to modify texture or any number of characteristics of a dough composition of the invention or a baked product resulting therefrom. A nutritional supplement such as, for example, vitamins, minerals, proteins, and the like can be added to a dough composition of the invention. Examples of nutritional supplements include thiamin, riboflavin, niacin, iron, calcium, etc. Flavorings such as, for example, sweeteners, spices, and specific natural and artificial flavorings can be added to a dough composition of the invention. Shelf-life stabilizers such as, for example, preservatives and mold inhibitors can be added to a dough composition of the invention. Suitable shelf-life stabilizers include, for example, sodium salts of propionic or sorbic acids, sodium diacetate, monocalcium phosphate, lactic acid, stearoyl lactylate, ascorbic acid, and the like, or combinations thereof.

Exemplary suitable protein supplements can include proteins resulting from amino acids such as, for example glycine, alanine, leucine, isoleucine, valine, phentolanine, turicine, tryptophan, proline, methionine, cystine, serine, threonine, asparagine, glutamine, histidine, aspartic acid, glutamic acid, lysine, arginine, or combinations or mixtures thereof. Other suitable protein supplements include, for example, a-keratin, collagen, fibroin, sclerolin, myosin, actin, carboxypeptidase, trypsin, ovalbumin, casein, and the like.

Typical dough compositions useful in this invention include, on a parts by weight per 100 parts of flour basis unless otherwise specified:

| Ingredient | Useful Range | Exemplary Range |
|---|---|---|
| Wheat Flour, Bagel | 100 | 100 |
| Water | 40-60 | 45-55 |
| Vital Wheat Gluten | 0-10 | 0.1-4 |
| HF Corn Syrup or Sugar | 0-10 | 1-10 |
| Yeast, fresh | 0.1-6 | 0.5-4 |
| Salt | 0-5 | 0.5-3 |
| Softeners | 0-3 | 0.5-1.5 |
| Preservatives | 0-3 | 0.1-1 |
| Reducing Agents | 0-1 | 0.0005-0.01 |
| Ozidizing Agents, blowing | 0-1 | 0.0005-0.05 |
| agents, citric acid | | |

One function of dough conditioners is the softening of the dough, brought about by the inclusion in the dough formula of reducing agents. These act on the disulfide bonds of the wheat proteins, particularly the gluten proteins, rendering the dough soft and pliable and giving it the visco-elastic properties required. The most commonly used reducing agent is cysteine hydrochloride, often in combination with sodium metabisulfite. L-cysteine is a non-essential amino acid used as a reducing agent to reduce mixing time, increase machinability of dough, and to reduce shrinkage often associated with use of high protein flour. Cysteine hydrochloride must be used with great care as an overdose will excessively soften the dough and make it too sticky for the machines to process. In one embodiment reducing agents are used to form a bagel of the appropriate texture and consistency but with a lower water content, which can significantly extend shelf life. Such compositions useful in this invention include, on a parts by weight per 100 parts of flour basis unless otherwise specified, the following:

| Ingredient | Useful Range | Exemplary Range |
|---|---|---|
| Wheat Flour, Bagel | 100 | 100 |
| Water | 30-50 | 35-45 |
| Vital Wheat Gluten | 0-10 | 0.1-4 |
| HF Corn Syrup or Sugar | 0-10 | 1-10 |
| Yeast, fresh | 0.1-6 | 0.5-4 |
| Salt | 0-5 | 0.5-3 |
| Softeners | 0-3 | 0.5-1.5 |
| Preservatives | 0-3 | 0.1-1 |
| L-cystene | 5-100 ppm | 10-80 ppm |
| Modified Gluten | 0.5-3 | 0.5-3 |
| Oxidizing Agents, | 5-100 ppm | 20-40 ppm |
| Blowing Agents | | |
| (Ascorbic Acid, ADA, | | |
| and/or Bromate) | | |
| Antioxidant, e.g., | 0.25 to 3% | 0.5 to 2% |
| Glutathione | | |

Mixing Process.

All ingredients are combined together in a mixer as is commonly used in the art. Extensibility and elasticity is adjusted through mix times, ingredients and water content. Mixer settings and time of mixing are as known in the art. The ingredients when mixed produce a stiff, highly viscous bagel dough. Once the dough composition has been prepared, it is further processed to form a dough composition into a desired size and shape, followed by other processing steps such as packaging, freezing, and cooking.

B. Sheeting and Shaping

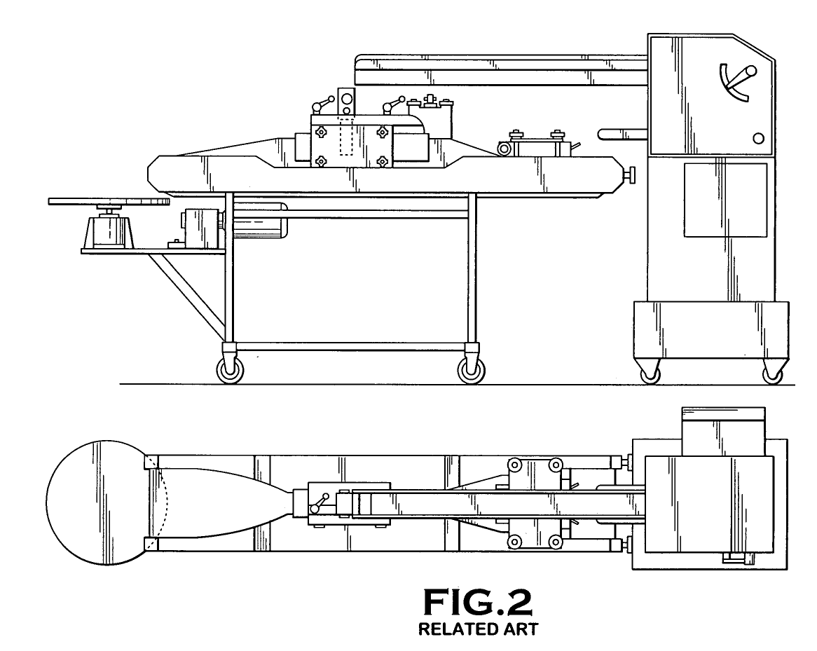

In the typical bagel dividing procedure, the dough is cut to the desired weight and each piece is formed into a bagel by rolling the dough piece ends until they form a circular piece. Conventional vertical or horizontal forming machines allow bakers, and commercial bagel manufacturers, to produce a greater number of bagels of uniform weight than using traditional hand-forming methods. See FIG. 2 of the specification.

The inventors have developed a new method for making shaped bagels. The present invention allows bakers and commercial bagel manufacturers to produce bagels in new non-traditional shapes. As is known in the art, bagel dough is a very dense and visco-elastic, the dough has a tendency to want to conform back to its original shape when distorted. In the new method for making shaped bagels, the mixed dough may be sheeted using a unique arrangement of dough sheeting equipment 100 to make either a square or rectangular bagel. The invention including both the machinery used as well as the process employed has a surprising ability to sheet, form, and slice highly viscous dough typical for bagel manufacturing on a sheeting table.

The proprietary ingredients are critical for allowing the viscous dough to be managed on the sheeting table. The critical ingredients include, in addition to bagel flour and water, enzyme modified gluten, potassium sorbate, calcium propionate, vital wheat gluten, ascorbic acid, salt, sugar, yeast, flour, water and enzymes. The ingredients also play a critical role in allowing the shelf life of the bagel to last two weeks at ambient temperatures.

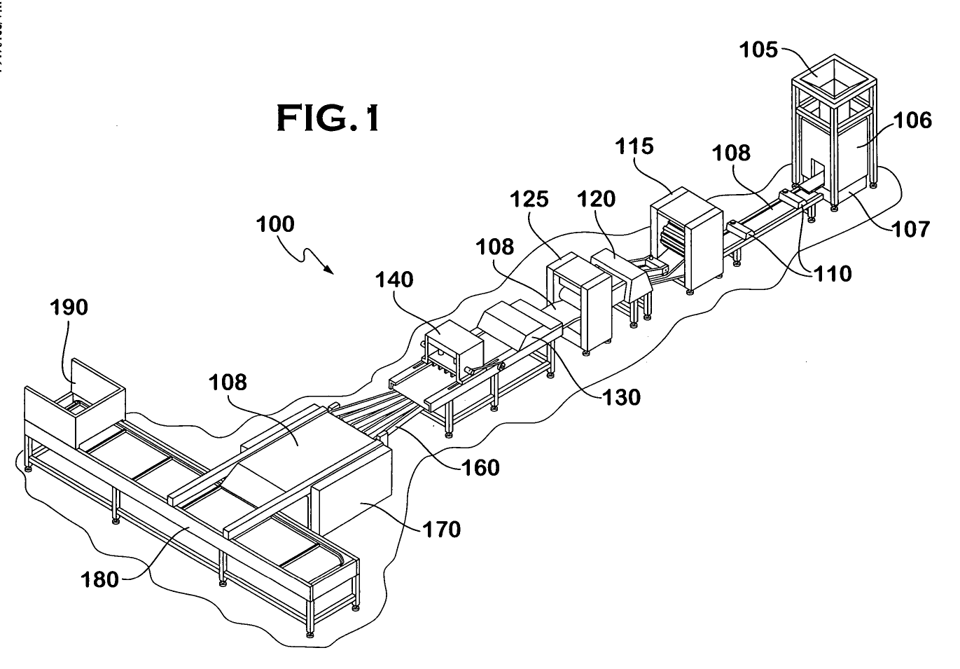

In one embodiment, the mixed dough may be delivered from a mixer via a manual dough trough feeder (not shown) to a one-thousand pound dough hopper 105 (dough reservoir/preportioner) where the dough descends into a chunker 106. The chunker 106 reduces the large dough deposit into about 30 to 45 pound portions and feeds a vertical laminator 107 (pre-divider) located below it with the proper quantity of dough. The vertical laminator 107 (pre-divider/feeder) can feed a continuous flow of dough about 12″ wide and 1.25″ thick depending on the dough consistency. See FIG. 1 of the specification.

Alternatively, dough can be continuously extruded, for example in a form of a thick continuous sheet.

The dough sheet is advantageously delivered to a sheeting table 108 conveyor through a pair of reduction rollers (not shown). The reduction rollers and sheeting conveyor may-move the dough sheet past two flour dusters 110 arranged in series that add flour to the conveyor surface and a top surface of the dough sheet in order to prevent sticking.

The sheeting table 108 directs the dough sheet to a plurality of rollers, for example a satellite roller assembly 115, a cross roller 120, and a gauging roller station 125 arranged in series to produce a sheet of un-proofed dough that is between about 12 inches to 48 inches wide, preferably between about 18 inches to 32 inches wide, for example about 24.5 inches to 26 inches wide, and about 0.35 inches to about 0.75 inches, typically between about 0.4 inches to 0.6 inches thick, for example about 0.45 inches to 0.55 inches thick. The satellite roller 115 and the cross roller 120 reduce the dough sheet thickness and advantageously spreads the dough until the desired width is attained. A flour duster 110 may be added between the satellite roller 115 and cross roller 120 to apply flour to the top of the dough sheet and mitigate sticking. Finally, advantageously a gauging roller station 125 reduces the dough sheet to its final thickness.

As shown in FIG. 1 of the specification, the gauged dough sheet can travel along the sheeting table 108 to a slitting device 130 comprising a plurality of rotary discs. Advantageously the sheeting table 108 is adapted to let the sheet of dough continuously move across the sheet toward a docker/cutter assembly 140, and at least the gauging roller 125 and the slitting device 130 can comprise rotatable elements that are stationary. In such a case, the top of the sheeting table 108 may move with the dough, or may be stationary if the dough will readily slide across the surface thereof. Alternatively, the operation can run in semi-batch mode where the dough is stationary on the stationary sheeting table and the rollers, dockers, and cutters move parallel to the face of the sheeting table. The slitting device slices the un-proofed dough into a plurality of separate sheets or ribbons, for example two to twelve, but in one preferred embodiment six (6) separate dough sheets or ribbons, that advantageously are about the width of the desired product, which is typically between 3 inches and 4.5 inches wide and is advantageously about 3.25 inches to 3.75 inches wide. Unused dough or scrap, which for example might include as much as about 1 inches to 1.75 inches from each side of the dough sheet, may be removed from the sheeting table 108 and deposited into a bin for collection or recycle. The use of such a wide sheet plus a square, rectangular, or less preferably and pentagon or hexagon shape allows many bagel products to be formed simultaneously from a single sheet of dough with little or no waste or re-cycle of dough. The cutters are most simplified when the desired product shape is square or rectangular.

Squares can be formed and then formed into octagons or rounded out by trimming of corners to form a more traditional form, but at the cost of additional dough that is wasted or that must be recycled.

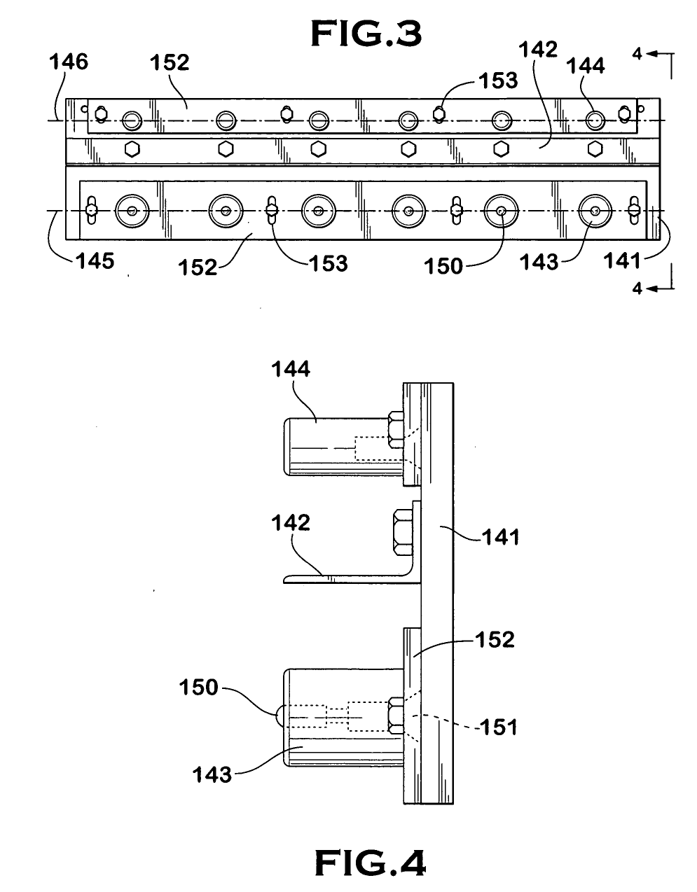

The six separate continuous sheets of dough can be conveyed along the sheeting table 108 to the docker/cutter assembly 140 including a docker/cutter plate 141 comprising a guillotine cutter 142 and at least two rows of dockers (145, 146) as shown in FIGS. 3 and 4. The guillotine cutter 142, located between both rows of dockers (145, 146), moves down through the un-proofed dough sheet or sheets and cuts the for example six separate dough sheets into a rectangular, square, or other geometric shape, but preferably square or rectangular bagels that are between about 3 inches and about 4.5 inches on a side, for example in a square or rectangular shape of length and width each between about 3.25 inches and 3.75 inches in length.

While a method of manufacturing square bagels can include the steps of 1) slit the dough, 2) docker the dough, and 3) cut the dough into pieces this is not a preferred combination. A preferred combination includes the steps of 1) docker the dough with a docker made from high-release food grade plastic or having spring loaded pushers, pins, or dowels in the docker, 2) cut the sheet into pieces, 3) docker the dough again with smaller dockers, and 4) slit the dough sheet. To make a more square product, at least one of cutting and slitting of the dough can advantageously take place after the step of forming the depression with the first docker, as this step can deform product. While the embodiments described here generally envision the steps of impressing the docker into the dough and cutting the dough product to be simultaneously, there can be dockers upstream which form initial depressions in combination with “finishing” dockers near or adjacent to the cutting blade. To maintain registration, advantageously such dockers can be fixed onto the docker/cutter plate, though processes where a docker may work “independent” of the docker/cutter plate can be envisioned.

For bagels with toppings, e.g., bagels topped with seeds or the “everything” bagel that may have seeds, spices, salts, and such, it is advantageous to wet the top of the dough before adding the topping. Much better topping adhesion is obtained if the dough is wetted, the topping added, and then the topping is pressed into the dough. The apparatus and method of making non-traditional bagels according to this invention are particularly suited for such a process, while the dough is in the flat sheet form. So after the roller or rollers have made the dough sheet flat and of a desired thickness, then advantageously the dough is wetted by for example a mist, topping is added, and then the topping is pressed into the dough, for example with another roller. While this may occur after the dough sheet has been slit, cut into individual bagel-sized pieces, and had a depression made therein by being pressed with a docker 143, the adding and pressing of the topping is preferably completed at least before the bagel sheet encounters the docker/cutter plate 141. Alternatively, the topping can be pressed by the docker/cutter assembly 140 providing the docker/cutter plate 141 further comprises a pressing plate (not shown) moving for example with the docker 143 or independent of the docker to press against the top surface of the dough sheet while the docker 143 and cutter 142 are being urged into the dough sheet.

Advantageously prior to or simultaneous with the cutting, a first docker row 145 engages the uncut dough sheets preceding the guillotine cutter 142 with a cylindrical docker 143 between about 0.5 inches to 1.75 inches in diameter, for example between about 0.5 inches and 1.25 inches inches in diameter, but preferably about 0.75 inches to 1.0 inch in diameter. Advantageously, the docker 143 has a cross section that is circular, to form a traditional circular hole. The docker 143 may be an oval, a square, or other geometric shapes to form a more distinctive product, where the “diameter” is then taken to be the longest straight distance from one side of the docker to the opposite side of the docker. The docker 143 may be tapered, such that the diameter within an eighth inch or so from the pressing face is between about 0.01 inches and 0.25 inches smaller than the docker diameter at the surface of the dough sheet, to facilitate dough release. In such a case the docker diameter is taken to be the diameter of the docker 143 at the top surface of the dough when the docker is fully impressed into the dough. A flour duster 110 may be added before the docker/cutter assembly 140 to apply flour to the top of the dough sheet and mitigate sticking.

In a preferred embodiment, unproofed dough is subject to a second docker row 146, which can be before or after the cutter 142. If the docker/cutter/docker or docker/docker/cutter arrangement is in one solid piece, then the second docker row 146 should be positioned either one, two, or some other integer of un-proofed dough product lengths from the first docker 143 to simultaneously press the second docker 144 into the preformed hole or depression at the same time the first docker 143 is forming a hole in the advancing or next dough sheet. The cutter 142 can advantageously cut the ribbon of dough into individual dough shapes, where the cutting is done simultaneously with the impressing of the first and second dockers into the respective pieces of dough. In a preferred embodiment, the second docker row 146 engages the severed dough squares following the guillotine cutter 142 with a cylindrical docker of between about 0.25 inches to 1.25 inches in diameter, for example between about 0.375 inches and 0.75 inches wide, but preferably about 0.4 inches to 0.625 inches in diameter. Preferably the second docker 144 has a diameter at least one eighth inch less than the diameter of the first docker, and be of a high release material (such as a fluoroplastic) so that a dowel is not needed to facilitate separation of the face of the second docker 144 from the dough. The dockers need not be cylindrical, and other shapes can be used including fanciful shapes uch as a square or triangle that can be useful for identifying the bagel product. The dockers may have extreme tapers or other forms, which will result in a product of a different appearance.

The dockers and dowels may be made of stainless steel, a food grade ceramic, or a suitable food grade plastic of which Delrin® or food grade unmodified type 6 nylon is preferred for toughness and resistance to spreading, and the like. Advantageously, at least the first docker may have a 0.03 inch to a 0.25 inch, for example a 0.1 inch to a 0.15 inch chamfer located adjacent to their distal end surface.

The docker/cutter plate 141 of the docker/cutter assembly 140 simultaneously cuts and presses the dough, translates along the sheeting table 108 at a speed equal to that of the moving dough, retracts from the sheeting table, and returns to its initial position in a four part sequence. First, the docker/cutter plate 141 translates downward to cut the dough and press it with the first and second docker rows (145, 146) while simultaneously moving horizontally at the same velocity as is the dough. The dockers 143 in the first docker row 145 are pressed into the top surface of the dough sheets and nearly, but advantageously not completely, penetrate the dough sheets. The docker 143 may be pressed completely through the dough sheet, but the resultant product may have a large hole extending completely therethrough. The cutter 142 may advantageously be fixed on the docker/cutter plate 141 and would therefore descend and cut the dough as the docker is descending and is being impressed into the dough. Second, the docker/cutter plate 141 substantially remains in the downward position, or may move slightly back up to begin the release of the dough from the face and sides of the docker or dockers impressed into the dough as the dough continues to move along the sheeting table 108. At this point, a spring-loaded dowel 150, pin or pusher may extend from the front of at least the first docker 143, and optionally from the face of second and/or third dowels if needed. This pin or pusher or dowel 150 should have a very light spring action, as it will be pushing against the very thin, e.g., 1/64 to ⅛ inch thick, layer of dough disposed under the face of the docker 143 to facilitate separation of the thin layer of dough from the docker. The dowel 150 or pin or pusher can be adapted to put a very small hole in the layer of dough, or alternatively to not puncture the layer of dough. Third, the docker/cutter plate 141 is withdrawn from the dough, and only after the dowel(s), dockers, and cutter(s) are separated from the dough is the fourth step begun, wherein the horizontal movement of the docker plate to match the movement of the dough is halted and reversed and the docker/cutter plate 141 moves back to its original position. Advantageously, this entire cycle takes place over a distance equal to the movement of the dough sheet over a distance which is a integer multiple (preferably 1) of the length of the square, rectangular, or other geometric shape of the un-proofed dough product. The drive mechanism used to urge the docker/cutter plate 141 toward the dough sheet and/or to provide movement of the docker/cutter plate 141 relative to the sheeting table 108 can each be any drive system known to be usable for food preparation, for example a screw, a chain, pneumatic drives such as pistons, or an electric motor. In one embodiment the docker/cutter plate 141 runs on or in tracks, grooves, or ridges (not shown) which guide and constrain the movement of the docker/cutter plate 141. If the cycle takes twice the time that the dough takes to move the length of the unproofed dough product, multiple rows of dockers and even a plurality of cutters may have to be on a docker/cutter plate 141, or alternatively but less preferably a plurality of docker/cutter plates may act in cooperation one with another to form and cut the advancing dough sheets or ribbons.

In a preferred embodiment, a paper-thin dough membrane remains on the bottom surface of the dough sheets after the dowels 150 and dockers 143 in the first docker row 145 are retracted. The thickness of this layer can be for example between about 1/64th and ⅛ inches thick, for example between approximately 1/32 and 1/16 of an inch thick. The diameter of the depression at the bottom may be 0.5 to 1.75 inches, but is typically between 0.75 and 1.25 inches. The thin layer of dough may have a hole punched therethrough, for example by the pin or pusher or dowel 150 used to separate the dough from the face of the dough. Said hole may be from 0.03 inches to 0.25 inches, for example, or large enough so that cooking water can drain through the hole.

Advantageously the docker/cutter plate 141 has first and second dockers (143, 144) or first and second rows (145, 146) of dockers where first and second dockers are separated by a distance such that when the first docker(s) 143 is being impressed in a new portion of the dough sheet, the second docker 144 is being impressed into the hole formed by the first docker 143 in the previous cycle. The cutter 142 may be disposed before the first docker 143, between the first and second dockers, or may be disposed after the second docker 144. Preferably the cutter 142 is disposed between the first and second dockers. Alternately, in a second cycle of the docker/cutter plate 141, which may be congruent with the above-described first cycle of the docker/cutter plate 141, the dockers 144 of the second docker row 146 are aligned with the holes created by the first docker row 145 and are pressed into the top surface of the dough sheets while it is cut into dough squares. The dockers 144 of the second docker row 146, which are advantageously narrower in diameter than those on the first docker row 145, push down the paper-thin dough membrane that is often pulled-up by the retraction of the first dockers/dowels from the dough sheets. Without flattening of the paper-thin membrane by the second docker row, the dough square may develop a protrusion instead of a belly-button shaped depression after proofing and baking.

The docker/cutter plate 141 in FIG. 3 shows that the centerlines of the cylindrical dowels 150 of the docker rows are preferably positioned equidistant from each other and from the cutting edge of the guillotine cutter 142. The docker dowels 150 are mounted on top of a holding screw 151 fixed to a row plate 152 and may be spring biased toward the dough sheet. The row plates 152 include slots 153 for adjustment and fixation to a front surface of the docker/cutter plate 141. Adjustment may be necessary to center the depression in the bagel product, as small variations are necessary when the dough composition is changed for example from refined flour to whole wheat flour, as the viscoelastic properties of the dough change. The guillotine cutter 142 also may be fixed to the front surface of the docker/cutter plate 141.

Other cutter arrangements can be used to form the final cut, for example a rolling cutter, but this cutter must be impressed into the dough and traverse across the width of the dough sheet or ribbon in the very short amount of time the docker assembly travels with the dough, so these other cutters are not preferred.

The dowels 150 of the first docker row 145 may be mounted on top of long holding screws 151 and extend slightly past the end of the fixed or spring-biased dowels. The dockers 143 of the first docker row 145 may be slightly compressed during application of the docker/cutter plate 141, and so the dowels 150 may penetrate the paper-thin membrane created by the dockers to form small holes in the bagel dough. The small holes partially close during the fermentation process and act as a drain for water added during a subsequent boiling or steaming step. Each small hole is important to the bagel baking process because water retained in the bagel dough depression can cause the bagel product to be misshaped during a baking step. The small hole may be sized to close when the bagel dough rises in the baking step. After the baking step, a belly-button shaped depression in the middle of the top surface of the square bagel is preferably a nickel or dime in diameter sized depression. So while the finished product will appear to have a hole therein, there will typically not be a hole present in the top half when a finished bagel product of this invention is sliced in half to make for example a sandwich. Alternatively, there may be a hole present in the top half, but not the bottom half when a finished bagel product of this invention is sliced in half to make for example a sandwich.

Individually cut and docketed square bagels may be conveyed to spreading belts 160 where differences in the belts' speed separate and spread the square bagels away from each other. See FIG. 1 of the specification. The individual columns, e.g., the six columns of square bagels may be sent to a reciprocator 170. The reciprocator 170 may convey five (5) rows by six columns of bagels (or 30 square bagels) toward an orthogonal board indexing conveyor 180. The board indexing conveyor receives the reciprocated square bagels onto a proofing board 190 made of a high-release material, e.g., Teflon™ and dusted with cornmeal. Once loaded onto the proofing board 190, the board is translated to one side of the sheeting table 108 where it may be removed and placed into a rack within a proofing enclosure (not shown).

C. Proofing

The proofing enclosure is temperature controlled so the bagels rise (fermentation) the desired amount. The pre-formed bagel-sized portions can be proofed as is known in the art. The square bagels preferably are proofed in the enclosure between 1 and 1.5 hours at between 100° F. to 110° F. The proofing enclosure is preferably made of stainless steel. After proofing, the square bagels may continue fermentation by storing in a refrigerated storing area.

The production rate for square bagels is expected to be about 120 to about 600, for example about 200 to about 400 pieces per minute. It can be appreciated that the equipment and process can be scaled up or down. In a preferred commercial embodiment, he production rate for square bagels is about 270 pieces per minute which equals 11 boards per minute having 6 bagels across and 45 strokes (cutting and forming the indentation).

D. Processing

Topping.

The fermented square bagels can be transferred to a conveyor and may be topped with seeds or flavored food ingredients as is known in the art. It may be advantageous to wet a surface of the bagel to enhance sticking of seeds as is known in the art.

Boiling or Steaming.

A boiling or steaming process can be applied to achieve a thicker crust and shine on the square bagel. Steaming is preferred for an automated process. If steaming is used alone, generally the steaming process takes several minutes to fully cook the bagel. The bagel products may be steamed and then baked. In one preferred embodiment, the square bagels are steamed and baked concurrently in an oven. In another embodiment, the square bagel is boiled or steamed for a period of time less than is necessary to fully cook the bagel, for example between about 45-50 seconds, and then the resulting partially cooked bagels are baked in an oven with or without steam.

Baking.

The bagel dough pieces are baked to time, temperature and color. The baking may be completed in lieu of steaming, but preferably (depending on the desired texture) the baking is done in addition to steaming. Preservatives and glaze may be sprayed on the outside of the bagel prior to discharging the bagel products from the oven or alternatively at the oven discharge, which advantageously provide an effective coating of preservative on the outside of the bagel product.

Cooling and Packaging.

The product is advantageously cooled to near ambient temperature. The product may be dried as necessary. The square bagel may require a specially designed bagger, for example a bagger of a type more typically used for square bread, to place the bagel square into a square bottom bag.

### E. EXAMPLES

### Example 1

### Square Formula Ingredient Ranges are Shown Below

The ingredients are provided on a “pounds per 100 pounds of flour” basis in the Examples.

| Ingredients | |
|---|---|
| Wheat Flour, Bagel | 100 |
| Water | 40-60 |
| Vital Wheat Gluten | 0-10 |
| HF Corn Syrup or Sugar | 0-10 |
| Yeast, fresh | 0-5 |
| Salt | 0-5 |
| Softeners | 0-3 |
| Preservatives | 0-3 |
| Reducing Agents | 0-1 |
| Ozidizing Agents | 0-1 |

### Example 2

### The Following Formula was Found to be Useful in the Preparation of Square Bagel Product

| Ingredients | |
|---|---|
| Wheat Flour, Bagel | 100 |
| Water | 49 |
| Vital Wheat Gluten | 2 |
| HF Corn Syrup or Sugar | 10 |
| Yeast, fresh | 4 |
| Salt | 2 |
| Softeners | 1 |
| Preservatives | 0.5 |
| Reducing Agents (Lcystene) | 10 ppm |
| Ozidizing Agents | 30 ppm |
| (Ascorbic Acid, ADA, or potassium Bromate) | |

### Example 3

Square Formula with Reducing Agents

Reducing agents can be used to reduce the amount of water needed in the formulation.

| Ingredients | |
|---|---|
| Wheat Flour, Bagel | 100 |
| Water | 30-50% |
| Vital Wheat Gluten | 2 |
| HF Corn Syrup or Sugar | 10 |
| Yeast, fresh | 4 |
| Salt | 2 |
| Softeners | 1 |
| Preservatives | 0.5 |
| L-cystene | 5-100 ppm |
| Modified Gluten | 0.5-3 |
| Oxidizing Agents | 30 ppm |
| (Ascorbic Acid, ADA, or Bromate) | |
| Glutathione | 0.25 to 3% |

Advantageously the non-traditional bagel products of the present invention have a taste and consistency of a bagel while having a square shape amenable to forming a sandwich, wherein the non-traditional bagel product has a indentation approximately centrally located in the top surface of the bagel product and having the appearance of a traditional hole in a rolled bagel.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

We claim:

1. A dough sheeting apparatus for sheeting highly viscous bagel dough to form a bagel dough piece, the apparatus comprising:
a) a sheeting table to which is supplied dough;
b) at least one roller adapted to flatten the dough to a dough sheet having a thickness between about ⅜ inch and ¾ inch;
c) a docker/cutter plate comprising at least one guillotine style cutting blade and at least one docker adapted to be pressed into and to form a depression in the dough and having a diameter between about 0.5 inches to 1.75 inches, wherein the docker/cutter plate is attached to a driving mechanism adapted to move the docker/cutter plate toward and into the dough sheet to a predetermined distance such that the cutting blade cuts the dough sheet and the docker is simultaneously pressed into the dough sheet a distance which is less than the thickness of the dough sheet, and then to withdraw the docker/cutter plate from the dough.

2. The dough sheeting apparatus of claim 1, wherein the cutter extends outward from the docker/cutter plate further than does the face of the docker such that the docker does not pass completely through the thickness of the dough sheet when the docker/cutter plate has moved to the pre-determined distance towards and into the dough, the docker further comprising an extendible dowel which extends from the face of the docker as the docker is being withdrawn from the dough to facilitate separation of dough from the face of the docker.

3. The dough sheeting apparatus of claim 2, wherein the dowel forms a hole less than ¼ inch in diameter through the dough sheet, and wherein the docker/cutter plate further comprises a second docker adapted to be inserted into the depression previously formed by the first docker, and wherein said second docker is positioned such that when the docker/cutter plate moved toward and into the dough sheet the second docker is inserted into the depression previously formed by the first docker at the same time that the first docker is forming a new depression in the dough sheet.

4. The dough sheeting apparatus of claim 1, wherein the dough moves continuously across the face of the sheeting table, wherein the docker/cutter plate is attached to a moving mechanism which moves the docker/cutter plate from a starting position horizontally at a velocity about the same as the velocity the dough is moving across the face of the sheeting table while the driving mechanism is moving the docker/cutter plate toward and into the dough sheet to a predetermined distance and then to withdrawing the docker/cutter plate from the dough, wherein said moving mechanism after the docker/cutter plate has been withdrawn from the dough then moves the docker/cutter plate back to the starting position.

5. The dough sheeting apparatus of claim 1, wherein the docker/cutter plate further comprises a second docker adapted to be inserted into the depression previously formed by the first docker, and wherein said second docker is positioned such that when the docker/cutter plate is moved toward and into the dough sheet the second docker is inserted into the depression previously formed by the first docker at the same time the first docker is forming a new depression in the dough sheet.

6. The dough sheeting apparatus of claim 5, wherein the first docker and the second docker are each disposed on the docker/cutter plate in a position before the cutter.

7. The dough sheeting apparatus of claim 5, wherein the cutter is disposed between the first docker and the second docker.

8. The dough sheeting apparatus of claim 1, further comprising a slitting device to cut the dough sheet into a plurality of dough ribbons each having a width between about 3 inches and 4.5, and wherein the docker/cutter plate comprises a plurality of first dockers separated one from another by a distance such that when the docker/cutter plate is moved toward and into the dough a first docker forms a depression in each separate dough ribbon.

9. The dough sheeting apparatus of claim 8, wherein the docker/cutter plate further comprises a plurality of second dockers adapted to be inserted into the depressions previously formed by the first dockers, and wherein said second dockers are positioned such that when the docker/cutter plate is moved toward and into the dough sheet the second dockers are inserted into the depression previously formed by the first docker at the same time the first docker is forming a new depression in the dough sheet.

10. The dough sheeting apparatus of claim 9, wherein the first dockers and the second dockers are each disposed on the docker/cutter plate in a position before the cutter.

11. The dough sheeting apparatus of claim 9, wherein the cutter is disposed between the first dockers and the second dockers.

12. The dough sheeting system according to claim 8, further comprising
iv) a spreading belt conveyor having a plurality of belts to spread the dough pieces into columns separate from each other; and
v) a reciprocating conveyor for conveying a plurality of columns and rows of dough pieces toward a board indexing conveyor; and
vi) the board indexing conveyor having a proofing board to receive the plurality of columns and rows of dough pieces and to translate the proofing board to at least one side of the sheeting table.

13. The dough sheeting system according to claim 8, wherein the slitting device and the docker/cutter plate is adapted to cuts the plurality of dough sheet ribbons into square or rectangular shapes having a length and width between about 3 and about 4.5 inches, and having a depression centrally located in the square or rectangular shapes having a diameter between about.

14. The dough sheeting system according to claim 8, wherein the docker/cutter plate includes the guillotine style cutting blade located between the plurality of dowels arranged in at least a first docker row comprising the first dockers and a second docker row comprising the second dockers.

15. The dough sheeting system according to claim 14, wherein the dockers are substantially cylindrical and comprise a 0.05 inch to a 0.25 inch chamfer, wherein each of the plurality of cylindrical dockers in the first docker row is between 0.5 inches to 1.5 inches wide.

16. The dough sheeting system according to claim 7, wherein each of the plurality of cylindrical dowels in a second docker row is between 0.375 inches to 0.75 inches wide.

17. The dough sheeting system according to claim 1, wherein the docker includes a distal end having a chamfer and further includes a taper such that when maximally inserted into the dough sheet the pressing face is between about 0.01 inches and 0.25 inches smaller in diameter than the docker diameter at the surface of the dough sheet.

18. The dough sheeting system according to claim 4, wherein the cutter cuts the dough sheet into square or rectangular pieces, and wherein the docker/cutter plate translates along the sheeting table while engaged with the dough sheets from the starting position to a second position wherein the docker/cutter plate retracts from engaging the dough sheet after it translated along the sheeting table the required distance, and subsequently moves back to the starting position is about the time the dough moves a distance substantially the same distance as a distance equal to the square or rectangular shape cut.

19. The dough sheeting system according to claim 11, wherein the thickness of the dough sheet within the area pressed by the first docker, excluding the area where the first docker has a chamfer, after the docker plate is retracted is between about between 0.03 and 0.08 inches thick.

20. A bagel producing apparatus comprising: a means for rolling unproofed dough into a dough sheet, a means for simultaneously creating a depression in the unproofed dough sheet and cutting off a portion of the unproofed dough sheet to form a square or rectangular bagel product having a depression approximately centrally located on a top face, means for separating and proofing the bagel products, and means for cooking the proofed bagel products.

21. A method for producing square- or rectangular-shaped bagels comprising:
sheeting bagel dough using dough sheeting equipment, wherein the dough comprises, per 100 parts by weight of wheat flour, between 40 and 60 parts water;
shaping the bagel dough into one or more predetermined square or rectangular shapes using a slitting means and a cutting means to obtain a shaped bagel dough;
forming a depression in the shaped bagel dough via a docker-type device being pressed into the bagel dough; and
processing and cooking the shaped bagel dough to produce a shaped bagel having a square- or rectangular-shape and having a depression substantially centrally located in the top face thereof, where the depression has a diameter of at least 0.5 inches and does not extend through the shaped bagel.

22. The method of claim 21 wherein a hole having a diameter less than 0.25 inches extends from the bottom of the depression and through the shaped bagel.

23. The method of claim 21, wherein the bagel dough comprises at least the following ingredients: wheat flour, water, vital wheat gluten, high fructose corn syrup, fresh yeast, salt, softeners, preservatives, 1-cystene, ozidizing agents, and ascorbic acid.

24. The method of claim 22, wherein the cooking includes, boiling or steaming, and wherein the hole is of sufficient diameter to allow any accumulated water to drain from the depression.

25. The method of claim 23, wherein the dough comprises an effective amount of reducing agents and between 35 and 45 parts water per 100 parts flour.

26. A non-traditional bagel product adapted to forming sandwiches and having a central depression located approximately centrally on the top surface thereof reminiscent of the traditional bagel hole, said product having the color, taste, and consistency of a traditional bagel while having a square, rectangular, pentagonal, or hexagonal shape, wherein the non-traditional bagel product if cut substantially in two even pieces along a horizontal plane will provide two halves, the top half having an indentation therein, and the bottom half not having a hole piercing through the center thereof.

27. The non-traditional bagel product of claim 26 comprising prior to cooking wheat flour, water in an amount between 0.3 and 0.6 times the weight of the wheat flour, enzyme modified gluten, potassium sorbate, calcium propionate, vital wheat gluten, ascorbic acid, salt, sugar, yeast , and enzymes.

28. The non-traditional bagel product of claim 26 wherein the central depression extends less than half-way through the thickness of the non-traditional bagel product.
